(19) United States
(12) Patent Application Publication
(10) Pub. No.: US 2016/0291906 A1
(43) Pub. Date: Oct. 6, 2016

(54) IMAGE PROCESSING DEVICE, IMAGE PROCESSING METHOD, PROGRAM, AND RECORDING MEDIUM

(71) Applicant: FUJIFILM Corporation, Tokyo (JP)

(72) Inventor: Shunsuke KOBAYASHI, Kanagawa (JP)

(73) Assignee: FUJIFILM Corporation, Tokyo (JP)

(21) Appl. No.: 15/070,374

(22) Filed: Mar. 15, 2016

(30) Foreign Application Priority Data
Mar. 30, 2015 (JP) 2015-068177

(51) Int. Cl. G06F 3/12; G06T 11/60

(52) U.S. Cl. CPC G06F 3/1243; G06T 11/60

(57) ABSTRACT

A frame image evaluation section evaluates, for each theme, each frame image based on a different evaluation reference to assign a score to the frame image, adds up the scores of the frame images to assign a score to each theme, and selects a predetermined number of themes in a descending order of the scores of the themes as candidate themes. A frame image correction section corrects, for each candidate theme, a predetermined number of frame images in a descending order of the scores of the frame images based on a different correction reference for each theme. A control section performs a control so that a name of each candidate theme and the predetermined number of frame images in the descending order of the scores of the frame images are displayed on the display section as candidate frame images, for each candidate theme.

### CROSS-REFERENCE TO RELATED APPLICATIONS

The present application claims priority under 35 U.S.C. §119 to Japanese Patent Application No. 2015-068177, filed Mar. 30, 2015, all of which are hereby expressly incorporated by reference into the present application.

### BACKGROUND OF THE INVENTION

1. Field of the Invention

The present invention relates to an image processing device, an image processing method, a program and a recording medium for selecting frame images and templates in a system or the like that creates printed matter of frame images extracted from a moving image.

2. Description of the Related Art

In recent years, portable terminals such as a smart phone or a tablet terminal have spread rapidly, and the number of still images (photographs) captured by these portable terminals has increased. In this regard, opportunities to capture a moving image have also increased. Recently, as a service that uses a moving image, as disclosed in “Moving image Photo! Service”, [online], Fujifilm Corporation, [Retrieved on Feb. 9, 2015], Internet <URL: http://fujifilm.jp/personal/print/photo/dogaphoto/>, a system that images (captures) printed matter such as a photograph using a portable terminal and then reproduces (AR-reproduces) a moving image related to the printed matter on a screen of the portable terminal using an augmented reality (AR) technique has been proposed.

In such a system, the AR reproduction of the moving image related to the printed matter is performed according to the following steps (1) to (6).

(1) If a user selects a moving image to be used in printing from among plural moving images using a dedicated-use application operated on a portable terminal, the selected moving image is uploaded to a server.

(2) The server extracts frame images of a representative scene from the moving image uploaded from the portable terminal.

(3) The frame images of the representative scene extracted by the server are downloaded to the portable terminal.

(4) The user selects a frame image to be printed from among the frame images of the representative scene displayed as a list on a screen of the portable terminal, and makes a printing order.

(5) The server generates printed matter of the frame image of the representative scene ordered by the user, and performs image processing for a moving image associated with the frame image for AR reproduction.

(6) After the delivered printed matter is imaged (captured) by the user using the portable terminal, the moving image for AR reproduction associated with the printed matter is downloaded from the server to be AR-reproduced on the screen of the portable terminal based on the AR technique.

In a system such as this that prints the frame images extracted from the moving image, if the frame images extracted from the moving image are printed as they are, in many cases, image quality becomes poor, and thus, it is difficult to obtain printed matter with a favorable appearance.

However, an enhancement in image quality can be expected by performing appropriate correction with respect to frame images, but it is difficult for a user to select a correction method suitable for the frame images. Further, it is preferable that the user can select frame images to be printed from among corrected frame images, that is, frame images in a state to be printed, but if the correction is performed with respect to all the frame images, the processing cost becomes high.

Further, when selecting templates (print mounts) used in combination with frame images to be printed, trial and error is inevitable for selecting templates that match a content of the frame images.

Here, as related art techniques related to the invention, there are JP2009-296172A which relates to an image processing device or the like that determines parameter values used in image processing to obtain desired image quality, JP2007-94990A which relates to an image dividing device or the like that divides plural images into plural groups, JP2009-152697A which relates to an imaging device or the like that displays a representative image suitable for a group including plural pieces of image data, JP2009-239889A which relates to a color processing system that performs color processing for an image, and JP2008-5239A which relates to an image correction device or the like that applies image correction to plural frames acquired from a moving image file.

### SUMMARY OF THE INVENTION

In order to solve the above problems, a first object of the invention is to provide an image processing device, an image processing method, a program and a recording medium capable of suitably correcting a frame image without increase in processing cost.

Further, a second object of the invention is to provide an image processing device, an image processing method capable of easily selecting a template that matches a frame image, and a program and a recording medium therefor.

According to an aspect of the invention, there is provided an image processing device including: a step of a frame image extraction section that extracts, for each theme, a plurality of frame images from a moving image based on a different extraction reference for each theme; a frame image evaluation section that, for each theme, assigns a score to each frame image by evaluating the frame image based on a different evaluation reference for each theme, assigns a score to each theme by adding up the scores of the frame images, and selects a predetermined number of themes in a descending order of the scores of the themes as candidate themes; a frame image correction section that corrects, for each candidate theme, a predetermined number of frame images in a descending order of the scores of the frame images based on a different correction reference for each theme; a display section; a control section that controls display of the display section; and an input section that receives a first instruction input for selecting one candidate theme from among the candidate themes displayed on the display section as a selected theme, input from a user, in which the control section performs a control, before the selected theme is selected, so that a name of each candidate theme and the predetermined number of frame images in the descending order of the scores of the frame images, corrected by the frame image correction section, are displayed on the display section as candidate frame images, for each candidate theme, and performs a control, after the selected theme is selected, so that a name of the selected theme and the candidate frame images of the selected theme corrected by the frame image correction section are displayed on the display section, according to the first instruction.

In the image processing device according to this aspect of the invention, it is preferable that the frame image correction section further sequentially corrects, after the name of the selected theme and the candidate frame images of the selected theme are displayed on the display section, the remaining frame images of the selected theme other than the candidate frame images thereof based on a correction reference of the selected theme, and the control section further performs a control, after the name of the selected theme and the candidate frame images of the selected theme are displayed on the display section, so that the remaining frame images of the selected theme sequentially corrected by the frame image correction section are sequentially displayed on the display section.

In the image processing device according to this aspect of the invention, it is preferable that the frame image correction section sequentially corrects the remaining frame images of the selected theme in the descending order of the scores of the frame images.

In the image processing device according to this aspect of the invention, it is preferable that the input section receives a second instruction for selecting one or more frame images from among the frame images of the selected theme displayed on the display section as selected frame images, input from the user, and the control section further performs a control so that templates corresponding to the number of the selected frame images and the selected theme among a plurality of templates are displayed on the display section as candidate templates, according to the second instruction.

In the image processing device according to this aspect of the invention, it is preferable that the input section further receives a third instruction for selecting one template from among the candidate templates of the selected theme displayed on the display section as a selection template, input from the user, and the image processing device further includes: a composite image generation section that generates a composite image using the selected frame image and the selection template according to the third instruction.

In the image processing device according to this aspect of the invention, it is preferable that the control section performs a control so that the frame images of the selected theme are displayed on the display section by being arranged in the descending order of the scores of the frame images.

In the image processing device according to this aspect of the invention, it is preferable that the control section performs a control so that the frame images of the selected theme are displayed on the display section by being arranged in a capturing order of the frame images.

In the image processing device according to this aspect of the invention, it is preferable that the control section performs a control so that the candidate themes are displayed on the display section by being arranged in the descending order of the scores of the themes.

In the image processing device according to this aspect of the invention, it is preferable that the control section performs a control so that the frame images of each candidate theme are displayed on the display section by being arranged in the descending order of the scores of the frame images, for each candidate theme.

According to another aspect of the invention, there is provided an image processing method including: a step of extracting, for each theme, a plurality of frame images from a moving image based on a different extraction reference for each theme, by a frame image extraction section; a step of evaluating, for each theme, assigning a score to each frame image by evaluating the frame image based on a different evaluation reference for each theme, assigning a score to each theme by adding up the scores of the frame images, and selecting a predetermined number of themes in a descending order of the scores of the themes as candidate themes, by a frame image evaluation section; a step of correcting, for each candidate theme, a predetermined number of frame images in a descending order of the scores of the frame images based on a different correction reference for each theme, by a frame image correction section; a step of performing a control so that a name of each candidate theme and the predetermined number of frame images in the descending order of the scores of the frame images, corrected by the frame image correction section, are displayed on the display section as candidate frame images, for each candidate theme, by a control section; a step of receiving a first instruction for selecting one candidate theme from among the candidate themes displayed on the display section as a selected theme, input from a user, by an input section; and a step of performing a control so that a name of the selected theme and the candidate frame images of the selected theme corrected by the frame image correction section are displayed on the display section, according to the first instruction, by the control section.

It is preferable that the image processing method according to this aspect of the invention further includes: a step of further sequentially correcting, after the name of the selected theme and the candidate frame images of the selected theme are displayed on the display section, the remaining frame images of the selected theme other than the candidate frame images of the selected theme based on a correction reference of the selected theme, by the frame image correction section; and a step of further performing a control, after the name of the selected theme and the candidate frame images of the selected theme are displayed on the display section, so that the remaining frame images of the selected theme sequentially corrected by the frame image correction section are sequentially displayed on the display section, by the control section.

It is preferable that the image processing method according to this aspect of the invention further includes: a step of receiving a second instruction for selecting one or more frame images from among the frame images of the selected theme displayed on the display section as selected frame images, input from the user, by the input section; and a step of performing a control so that templates corresponding to the number of the selected frame images and the selected theme among a plurality of templates are displayed on the display section as candidate templates, according to the second instruction, by the control section.

It is preferable that the image processing method according to this aspect of the invention further includes: a step of further receiving a third instruction for selecting one template from among the candidate templates of the selected theme displayed on the display section as a selection template, input from the user, by the input section; and a step of generating a composite image using the selected frame image and the selection template according to the third instruction, by a composite image generation section.

According to still another aspect of the invention, there is provided a program that causes a computer to execute the steps of the above-described image processing method.

According to still another aspect of the invention, there is provided a computer-readable recording medium that stores a program that causes a computer to execute the steps of the above-described image processing method.

According to the invention, by selecting only a theme having a high score among plural themes and performing correction with respect to only frame images having high scores among plural frame images, it is possible to efficiently perform subsequent processes without increase in processing cost for correction. Further, by correcting the frame images based on a different correction reference for each theme, it is possible to reduce a user's effort for selecting a suitable correction process, and to perform correction suitable for the frame images.

Further, according to the invention, when selecting templates, since the templates to be displayed are narrowed down to a predetermined number of candidate templates corresponding to the number of selected frame images and a selected theme, the user can easily select desired templates that match the selected frame images.

### BRIEF DESCRIPTION OF THE DRAWINGS

FIG. 1 is a block diagram illustrating an embodiment of a configuration of an image processing device of the invention.

FIG. 2 is a block diagram illustrating an embodiment of a configuration of a server shown in FIG. 1.

FIG. 3 is a block diagram of an embodiment illustrating an internal configuration of a portable terminal shown in FIG. 1.

FIG. 4 is a flowchart illustrating an example of an operation of an image processing device.

FIG. 5 is a conceptual diagram illustrating an example of the flow of a process in the image processing device.

FIG. 6 is a conceptual diagram illustrating an example of a state where a moving image is analyzed.

FIG. 7 is a conceptual diagram illustrating an example of a state where a frame image correction process is performed.

FIG. 8 is a conceptual diagram illustrating an example of a state where a theme is selected.

FIG. 9 is a conceptual diagram illustrating an example of a state where a frame image selection and correction process is performed.

FIG. 10 is a conceptual diagram illustrating an example of a state where a template is selected.

### DESCRIPTION OF THE PREFERRED EMBODIMENTS

Hereinafter, an image processing device, an image processing method, a program, and a recording medium of the invention will be described in detail based on preferred embodiments shown in the accompanying drawings.

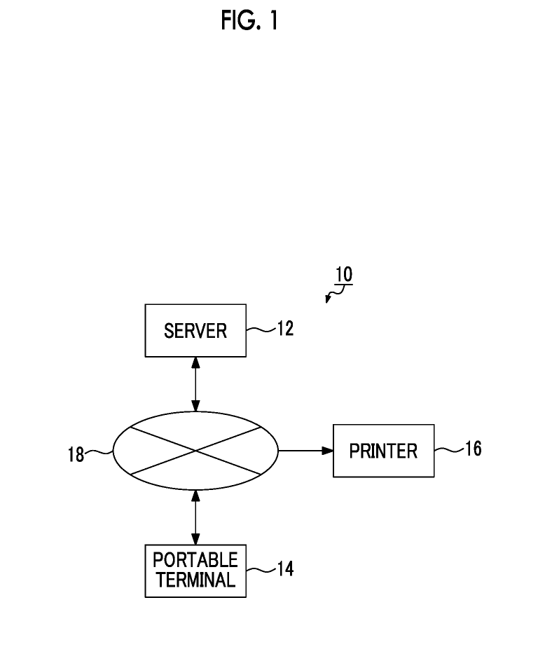

FIG. 1 is a block diagram illustrating an embodiment of a configuration of an image processing device of the invention. An image processing device 10 shown in FIG. 1 outputs a printed matter of a composite image generated using one or more frame images and a template selected by a user from among plural frame images extracted from a moving image, and includes a server 12, a portable terminal 14, and a printer 16. The server 12, the portable terminal 14, and the printer 16 are connected to each other through a network 18 such as the Internet.

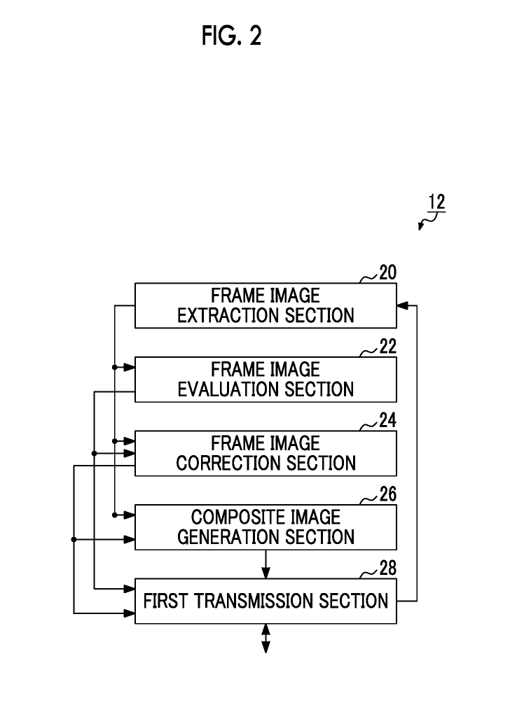

FIG. 2 is a block diagram of an embodiment illustrating a configuration of the server shown in FIG. 1. The server 12 shown in FIG. 2 has a CPU (Central Processing Unit), which is not shown in the Figure. The CPU performs by loading various programs thereon and controls a frame image extraction section 20, a frame image evaluation section 22, a frame image correction section 24, a composite image generation section 26, and a first transmission section 28.

In the frame image extraction section 20, for example, plural themes such as a person, a scene, a sports meeting or a birthday party are set in advance. The frame image extraction section 20 extracts, for each theme, plural frame images from a moving image based on a different extraction reference for each theme.

For example, in the case of the person theme, the frame image extraction section 20 extracts frame images in which a person is captured from a moving image. In the case of the scene theme, a scene is captured from a moving image to extract frame images in which a person is not captured. In other words, the frame image extraction section 20 extracts plural frame images from a moving image, and performs image analysis of the respective frame images to detect frame images in which a person is captured, or to detect frame images in which a scene is captured and a person is not captured.

Here, a method for extracting the frame images from the moving image is not limiting. For example, a user may manually extract desired frame images from a moving image, or frame images may be extracted from a moving image at a predetermined time interval.

Alternatively, a frame image which is a key in a scene change may be extracted using a key frame extraction (KFE) technique. In the KFE technique, for example, each frame image of a moving image is analyzed, and a color tone, brightness, blurring, and the like of the frame image are detected. Then, a frame image before or after the color tone or brightness is greatly changed, or a frame image in which blurring does not occur due to appropriate exposure is extracted.

Further, a size, a direction, and an expression (a smiling face, a crying face, or the like) of the face of a person in a moving image may be detected, and a frame image may be extracted based on the detection result. Further, when sound is included in a moving image, a frame image may be extracted from the moving image before or after a time point (time code) when the sound becomes large. By extracting a frame image from a moving image using the above-described method, it is possible to extract a representative scene of the moving image as the frame image.

The frame image evaluation section 22 evaluates, for each theme, each frame image extracted from the moving image by the frame image extraction section 20 based on a different evaluation reference for each theme to assign a score to the frame image. Further, the frame image evaluation section 22 adds up the scores of the frame images to assign a score to each theme, and selects a predetermined number of themes in a descending order of the scores of the themes as candidate scores.

For example, in the case of the person theme, as a result of the image analysis, a frame image in which a person is captured is assigned a score higher than that of a frame image in which the person is not captured. On the other hand, in the case of the scene theme, even in the same frame images as in the case of the person theme, a frame image in which a scene is captured and a person is not captured is assigned a score higher than that of a frame image in which both the scene and the person are captured.

A method for evaluating the frame images by the frame image evaluation section 22 is not limiting, and for example, the evaluation may be performed according to a different evaluation reference for each theme based on an image analysis result or the like. Further, the frame image evaluation section 22 may evaluate each frame image based on a common evaluation reference in plural themes such as a color tone, brightness or blurring, instead of the different evaluation reference for each theme, to increase or decrease a score.

The frame image correction section 24 corrects, for each candidate theme selected by the frame image evaluation section 22, a predetermined number of frame images in a descending order of the scores of the frame images based on a different correction reference for each theme.

For example, in the case of the person theme, the correction is performed so that the skin of a person seems nice. In the case of the scene theme, the correction is performed so that a primary color is brightly colored, or so that contrast or intensity is enhanced, in order to make a scene seem beautiful.

A method for correcting the frame images by the frame image correction section 24 is not limiting, and similarly, the correction may be performed according to a different correction reference for each theme based on an image analysis result or the like.

In the composite image generation section 26, plural types of template are retained for each theme. The composite image generation section 26 generates a composite image to be printed using a frame image and a template selected by a user.

The composite image generation section 26 sets a layout so that one or more frame images selected by the user are arranged at desired positions of a template selected by the user, for example, to generate a composite image.

The first transmission section 28 transmits a variety of data including moving images, themes, frame images, templates, composite images, or the like between the server 12 and the portable terminal 14. The first transmission section 28 comprises a device which performs publicity known wireless or wire communication.

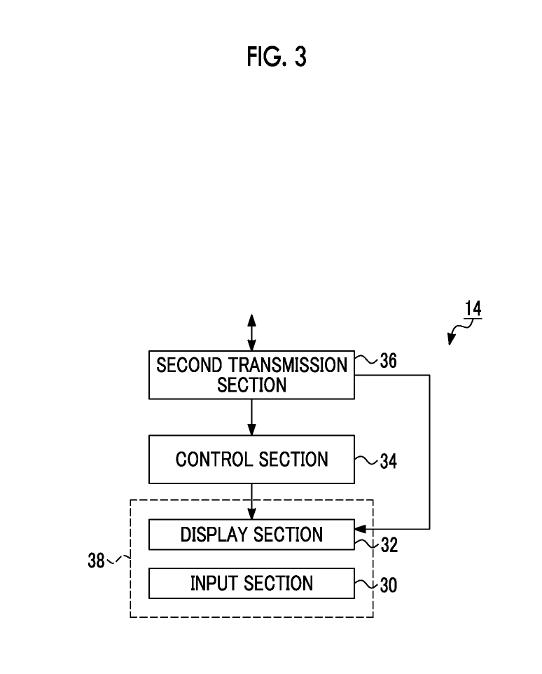

Subsequently, FIG. 3 is a block diagram of an embodiment illustrating an internal configuration of the portable terminal shown in FIG. 1. The portable terminal 14 shown in FIG. 3 is a smart phone, a tablet terminal or the like used by a user and has CPU which is not shown in the figure. The CPU performs by loading various programs thereon and controls an input section 30, a display section 32, a control section 34, and a second transmission section 36.

The input section 30 is a component through which various instructions are input from a user. The display section 32 displays a variety of information including moving images, themes, frame images, templates, or composite images. In this embodiment, a touch panel 38 forms the input section 30 and the display section 32.

The control section 34 controls display of the display section 32. The control section 34 performs a control so that a variety of information such as moving images, themes, frame images, composite images is displayed on the display section 32.

The second transmission section 36 transmits a variety of data including moving images, themes, frame images, templates, composite images or the like between the portable terminal 14 and the server 12. The second transmission section 36 comprises a device which performs publicity known wireless or wire communication.

The printer 16 prints a composite image generated by the composite image generation section 26 to output an output image (printed matter).

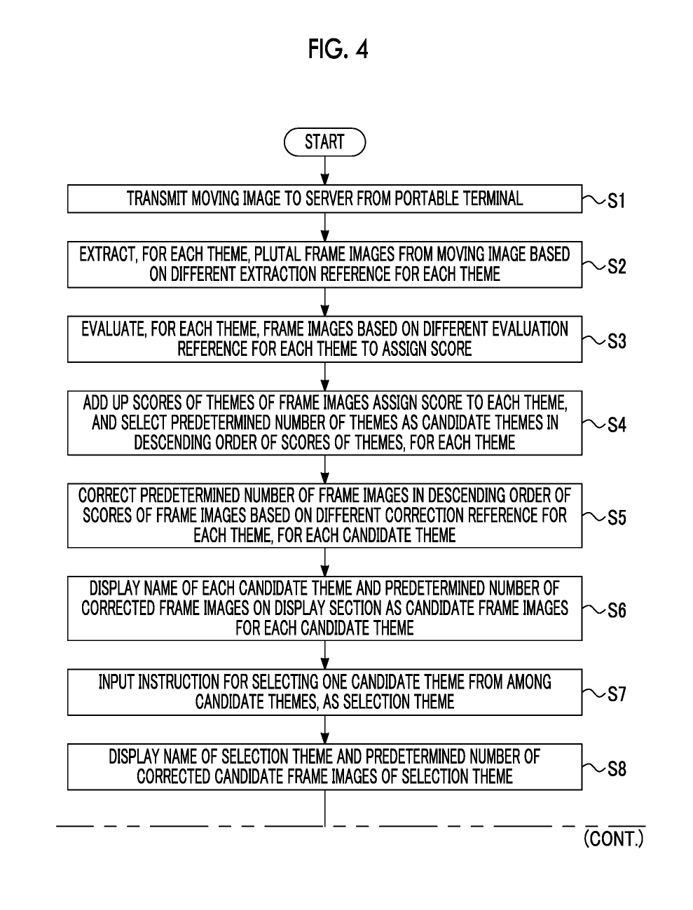

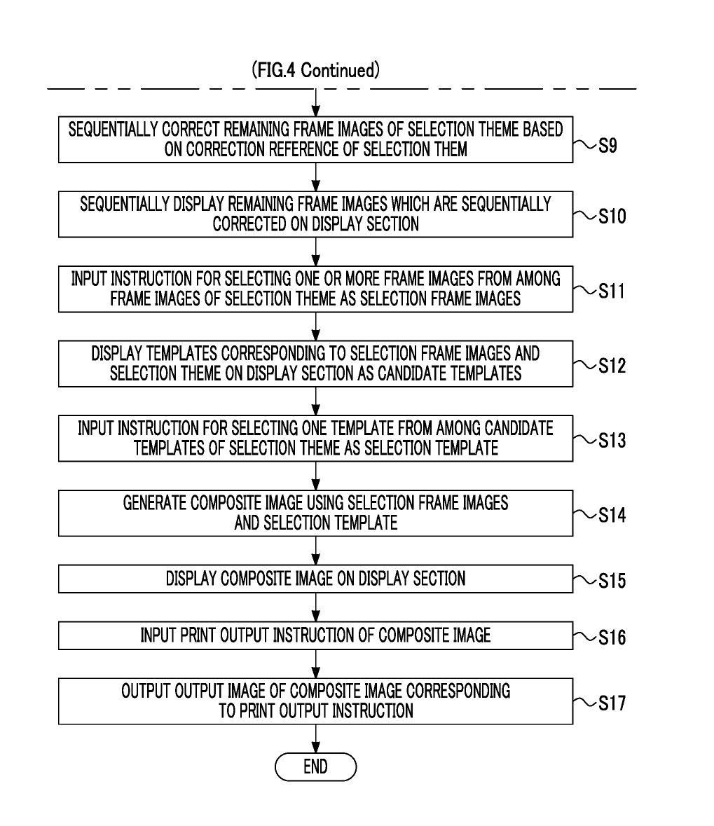

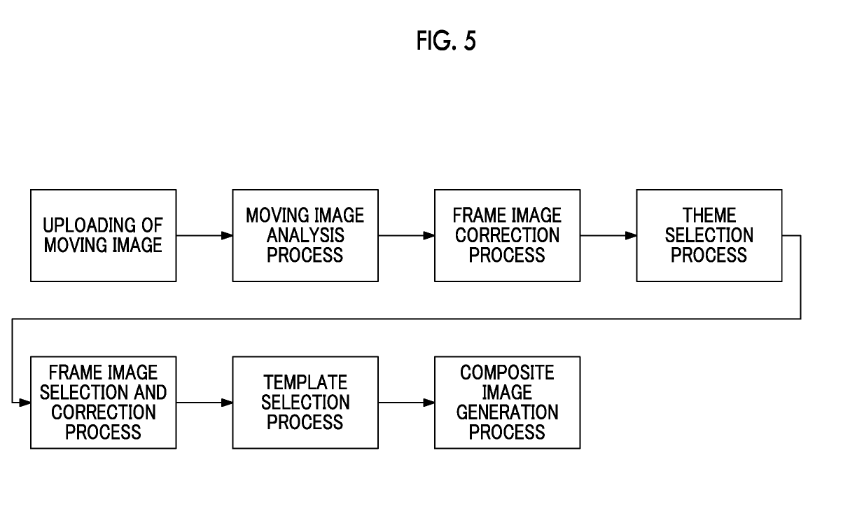

Next, an operation of the image processing device 10 will be described with reference to a flowchart shown in FIG. 4 and conceptual diagrams shown in FIGS. 5 to 10.

As shown in the conceptual diagram of FIG. 5, the image processing device 10 performs processes in the order of a moving image uploading process, a moving image analysis process, a frame image correction process, a theme selection process, a frame image selection and correction process, a template selection process, and a composite image generation process.

First, the moving image uploading process is performed.

In this case, a user operates the touch panel 38 (input section 30) to select one moving image from among moving images displayed on the touch panel 38 (display section 32) of the portable terminal 14, and inputs an instruction for transmitting the selected moving image (moving image data) to the server 12.

The moving image of which transmission is instructed is transmitted (uploaded) to the server 12 from the portable terminal 14 through the network 18 by the second transmission section 36 (step S1). The server 12 receives the moving image transmitted from the portable terminal 14 through the first transmission section 28.

Then, the moving image analysis process is performed.

In this case, plural frame images (moving image data) are extracted, for each theme, from the moving image received from the portable terminal 14 by the frame image extraction section 20 based on a different extraction reference for each theme (step S2).

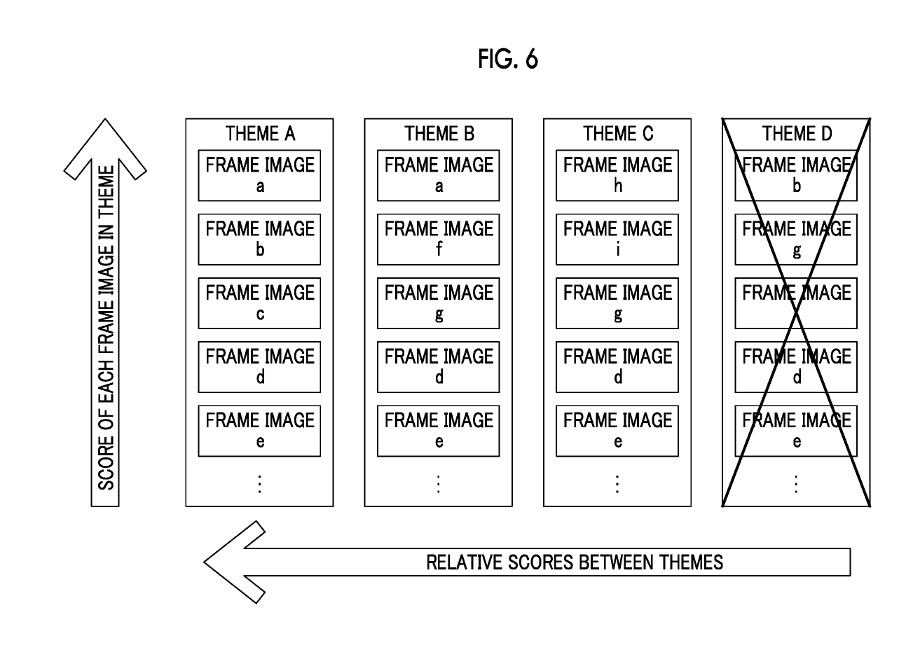

As shown in the conceptual diagram of FIG. 6, a case where four themes A, B, C, and D are set in advance may be considered. In this case, for example, a, b, c, d, e, . . . are extracted as frame images of the theme A; a, f, g, d, e, . . . are extracted as frame images of the theme B; h, i, d, g, e, . . . are extracted as frame images of the theme C; and b, g, a, d, e, . . . are extracted as frame images of the theme D.

Then, the frame image evaluation section 22 evaluates each frame image extracted from the moving image by the frame image extraction section 20 for each theme based on a different evaluation reference for each theme, and assigns a score to the frame image (step S3).

In the conceptual diagram of FIG. 6, in the figure, frame images are arranged in a descending order of the scores of the frame images from the top for each theme.

Subsequently, the frame image evaluation section 22 adds up the scores of the frame images for each theme, assigns a score to each theme, and selects a predetermined number of themes in a descending order of the scores of the themes (step S4).

In the conceptual diagram of FIG. 6, in the figure, themes are arranged in a descending order of the scores of the themes from the left side. Further, the themes A, B, and C are selected from among the themes A, B, C, and D, as candidate themes. The theme D which is not selected is not used in subsequent processes.

In this way, by assigning scores to all frame images of all themes, and calculating a score of each theme from the sum of the scores of the frame images, it is possible to specify a theme corresponding to content of a moving image with high accuracy. That is, it may be considered that as a score of a theme is high, a probability that the score of the theme matches a moving image is high. Further, by selecting only a theme having a high score from among plural themes, it is possible to efficiently perform subsequent processes without increasing the processing cost.

Subsequently, the frame image correction process is performed.

In this case, the frame image correction section 24 corrects a predetermined number of frame images for each candidate theme selected by the frame image evaluation section 22 in a descending order of the scores of the frame images based on a different evaluation reference for each theme (step S5).

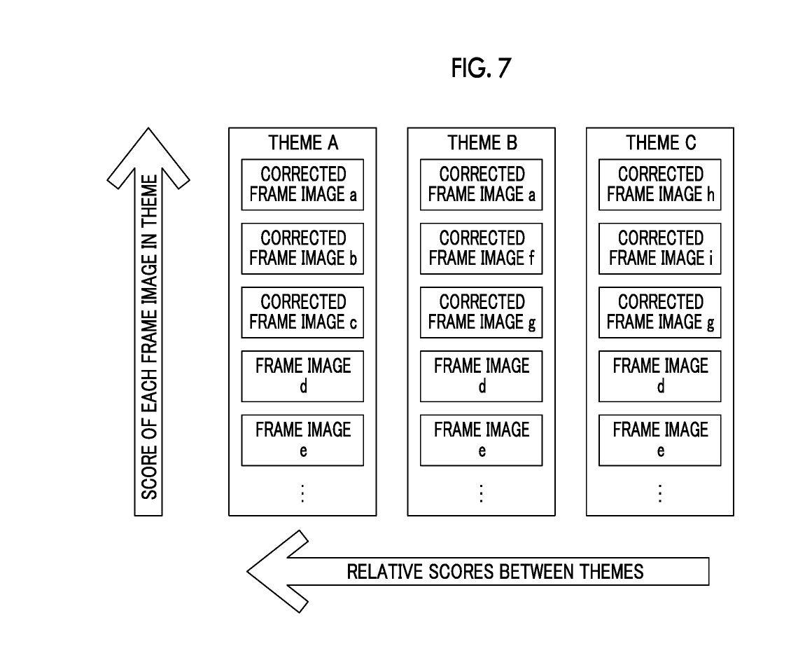

As shown in the conceptual diagram of FIG. 7, in the case of the candidate theme A, for example, three frame images a, b, and c among the frame images a, b, c, d, e, . . . in a descending order of the scores of the frame images are corrected based on a correction reference of the theme A. Similarly, in the case of the candidate theme B, three frame images a, f, and g among the frame images a, f, g, d, e, . . . are corrected based on a correction reference of the theme B, and three frame images h, i, and d among the frame images h, i, d, g, e, . . . are corrected based on a correction reference of the theme C.

By correcting frame images based on a different correction reference for each theme, that is, by correcting the frame images according to each theme, it is possible to reduce a user's effort for selecting a suitable correction process, and to perform correction suitable for the frame images. Further, by performing correction only with respect to a frame image having a high score among plural frame images, for each theme, it is possible to efficiently perform subsequent processes without increasing the processing cost for correction.

Then, the theme selection process is performed.

In this case, the predetermined number of frame images corrected by the frame image correction section 24 are transmitted to the portable terminal 14 from the server 12, for each theme.

In the portable terminal 14, a name of each candidate theme and the predetermined number of frames corrected by the frame image correction section 24 are list-displayed on the touch panel 38 (display section 32) as candidate frame images, for each candidate theme received from the server 12, under the control of the control section 34 (step S6).

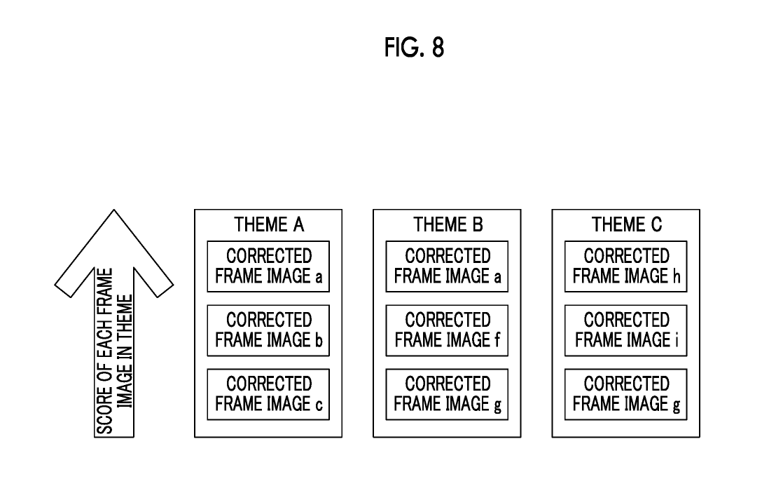

As shown in the conceptual diagram of FIG. 8, in the case of the candidate theme A, a name of the theme A and three corrected frame images a, b, and c are displayed as candidate frame images. Similarly, in the case of the candidate theme B, a name of the theme B and three corrected frame images a, f, and g are displayed as candidate frame images, and in the case of the candidate theme C, a name of the theme C and three corrected frame images h, and d are displayed as candidate frame images.

Here, a display order of the candidate themes is not limiting, but the candidate themes may be displayed on the touch panel 38 (display section 32) in a descending order of the scores of the themes from the left side, for example. Thus, a user can recognize a matching rate between a theme and content of a moving image. Further, a display order of the frame images of each candidate theme is not limiting, but the frame images of the candidate theme may be displayed on the touch panel 38 (display section 32) in a descending order of the scores of the frame images from the top, for each theme, for example.

Subsequently, the user operates the touch panel 38 (input section 30) to input an instruction for selecting one candidate theme from among the candidate themes list-displayed on the touch panel 38 (display section 32) as a selected theme (step S7).

When selecting a theme, since plural themes are narrowed down to a predetermined number of candidate themes, the user can easily select a desired theme from among the predetermined number of candidate themes. Further, by correcting the frame images based on a different correction reference for each theme and presenting the result to the user, the user can easily detect a difference in correction between the respective themes, and to reduce a burden of theme selection of the user. In addition, since the user can select a theme while viewing the corrected frame images, it is possible to more exactly determine theme selection while imaging frame images in a state of being actually printed.

Then, the frame image selection and correction process is performed.

In this case, a name of a selected theme selected by a user according to an instruction for selecting the selected theme and a predetermined number of corrected candidate frame images of the selected theme are displayed on the touch panel 38 (display section 32) under the control of the control section 34 (step S8).

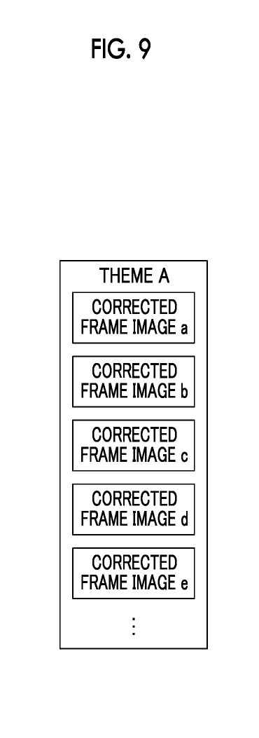

When the theme A is selected as the selected theme, as shown in the conceptual diagram of FIG. 9, the name of the theme A and the corrected three frame images a, b, and c are first displayed on the touch panel 38 (display section 32).

Further, the instruction for selecting the selected theme is transmitted to the server 12 from the portable terminal 14.

In the server 12, the frame image correction section 24 sequentially corrects the remaining frame images of the selected theme which are not yet corrected other than the predetermined number of corrected candidate frame images of the selected theme based on a correction reference of the selected theme, according to the instruction for selecting the selected theme (step S9).

Here, a correction order of the remaining frame images is not limiting, but for example, the remaining frame images of the selected theme may be sequentially corrected in a descending order of the scores of the frame images.

The remaining frame images which are sequentially corrected by the frame image correction section 24 are sequentially transmitted to the portable terminal 14 from the server 12.

Subsequently, in the portable terminal 14, the remaining frame images which are sequentially corrected by the frame image correction section 24 are sequentially displayed on the touch panel 38 (display section 32) under the control of the control section 34 (step S10).

As shown in the conceptual diagram of FIG. 9, the remaining frame images d, e, . . . , subsequent to the corrected three frame images a, b, and c, are sequentially displayed on the touch panel 38 (display section 32).

Here, a display order of the frame images of the selected theme is not limiting, but the frame images of the selected theme may be arranged in a descending order of the scores of the frame images or in a capturing order of the frame images to be displayed on the touch panel 38 (display section 32).

Subsequently, the user operates the touch panel 38 (input section 30) to input an instruction for selecting one or more frame images from among the frame images of the selected theme list-displayed on the touch panel 38 (display section 32) as selected frame images (step S11).

When selecting the frame images, since the frame images are narrowed down to only the frame images of the selected theme, the user can easily select desired frame images.

Then, the template selection process is performed.

In this case, an instruction for selecting the selected frame images is transmitted to the server 12 from the portable terminal 14.

Subsequently, in the server 12, the composite image generation section 26 selects templates corresponding to the number of selected frame images and the selected theme from among plural templates according to the instruction for selecting the selected frame images.

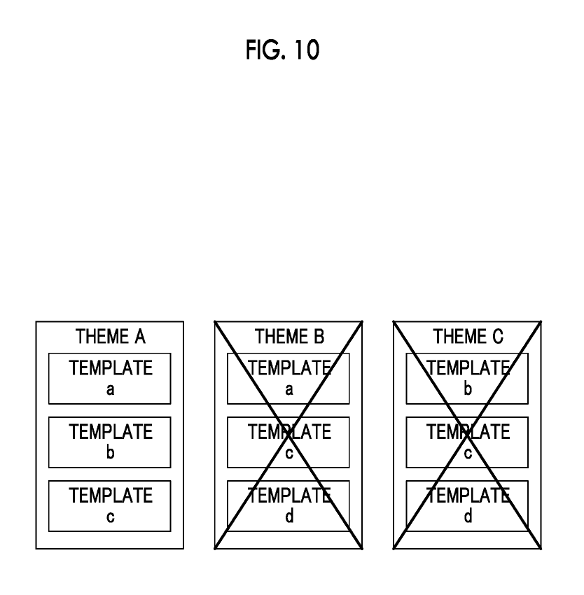

As shown in the conceptual diagram of FIG. 10, three templates a, b, and c corresponding to the number of selected frame images and the selected theme A are selected. Templates corresponding to the themes B and C are not selected.

The templates selected by the composite image generation section 26 are transmitted to the portable terminal 14 from the server 12.

Then, in the portable terminal 14, the templates received from the server 12 are list-displayed on the touch panel 38 (display section 32) as candidate templates according to an instruction for selecting the selected frame images under the control of the control section 34 (step S12).

Subsequently, the user operates the touch panel 38 (input section 30) to input an instruction for selecting one template from among the candidate templates of the selected theme list-displayed on the touch panel 38 (display section 32) as a selection template (step S13).

When selecting the templates, since the templates are narrowed down to a predetermined number of candidate templates corresponding to the number of selected frame images and the selected theme, the user can easily select desired templates that match the selected frame images.

Then, the composite image generation process is performed.

In this case, an instruction for selecting the selection template is transmitted to the server 12 from the portable terminal 14.

Subsequently, in the server 12 (step S14), the composite image generation section 26 generates a composite image using the selected frame images and the selection template according to the instruction for selecting the selection template (step S14).

The composite image generated by the composite image generation section 26 is transmitted to the portable terminal 14 from the server 12.

In the portable terminal 14, the composite image generated by the composite image generation section 26 is displayed on the touch panel 38 (display section 32) under the control of the control section 34 (step S15).

Then, the user operates the touch panel 38 (input section 30) to set a printing size of the composite image, the number of printed sheets, and the like, and to input a print output instruction of the composite image (step S16).

The print output instruction is transmitted to the server 12 from the portable terminal 14.

In the server 12, a composite image corresponding to the print output instruction received from the portable terminal 14 is transmitted to the printer 16 from the composite image generation section 26, and an output image (printed matter) of the composite image is output by the printer 16 (step S17).

It is not essential that the portable terminal 14 is used, and instead, a control apparatus such as a personal computer or the like including the input section 30, the display section 32, the control section 34, and the second transmission section 36 may be used. Further, an example in which the server 12 and the portable terminal 14 are divided is shown, but the invention is not limited thereto, and a configuration in which the server 12 and the portable terminal 14 is formed as a single processing device may be used. In this case, the first transmission section 28 and the second transmission section 36 are not essential.

Further, a configuration in which after the theme is selected, the remaining frame images of the selected theme are sequentially corrected is described, but this configuration is not essential.

In this case, the control section 34 performs a control, after the theme is selected, so that the name of the selected theme and the candidate frame images of the selected theme corrected by the frame image correction section 24 are displayed on the display section 32 according to an instruction for selecting the theme, and performs a control so that the remaining frame images which are not corrected are displayed on the display section 32 as necessary.

The device of the invention may be configured so that the respective components of the device are formed by exclusive-use hardware, or may be configured by a computer in which the respective components are programmed.

The method of the invention may be executed by a program that causes a computer to execute respective steps thereof, for example. Further, a computer-readable recording medium that stores the program may also be provided.

The invention basically has the above-described configuration.

Hereinabove, the invention has been described in detail, but the invention is not limited to the above-described embodiments, and may include various improvements or modifications in a range without departing from the spirit of the invention.

What is claimed is:

1. An image processing device comprising:
a frame image extraction section that extracts, for each theme, a plurality of frame images from a moving image based on a different extraction reference for each theme;
a frame image evaluation section that, for each theme, assigns a score to each frame image by evaluating the frame image based on a different evaluation reference for each theme, assigns a score to each theme by adding up the scores of the frame images, and selects a predetermined number of themes in a descending order of the scores of the themes as candidate themes;
a frame image correction section that corrects, for each candidate theme, a predetermined number of frame images in a descending order of the scores of the frame images based on a different correction reference for each theme;
a display section;
a control section that controls display of the display section; and
an input section that receives a first instruction input for selecting one candidate theme from among the candidate themes displayed on the display section as a selected theme, input from a user,
wherein the control section performs a control, before the selected theme is selected, so that a name of each candidate theme and the predetermined number of frame images in the descending order of the scores of the frame images, corrected by the frame image correction section, are displayed on the display section as candidate frame images, for each candidate theme, and performs a control, after the selected theme is selected, so that a name of the selected theme and the candidate frame images of the selected theme corrected by the frame image correction section are displayed on the display section, according to the first instruction.

2. The image processing device according to claim 1,
wherein the frame image correction section further sequentially corrects, after the name of the selected theme and the candidate frame images of the selected theme are displayed on the display section, the remaining frame images of the selected theme other than the candidate frame images thereof based on a correction reference of the selected theme, and
wherein the control section further performs a control, after the name of the selected theme and the candidate frame images of the selected theme are displayed on the display section, so that the remaining frame images of the selected theme sequentially corrected by the frame image correction section are sequentially displayed on the display section.

3. The image processing device according to claim 2,
wherein the frame image correction section sequentially corrects the remaining frame images of the selected theme in the descending order of the scores of the frame images.

4. The image processing device according to claim 1,
wherein the input section receives a second instruction for selecting one or more frame images from among the frame images of the selected theme displayed on the display section as selected frame images, input from the user, and
wherein the control section further performs a control so that templates corresponding to the number of the selected frame images and the selected theme among a plurality of templates are displayed on the display section as candidate templates, according to the second instruction.

5. The image processing device according to claim 2,
wherein the input section receives a second instruction for selecting one or more frame images from among the frame images of the selected theme displayed on the display section as selected frame images, input from the user, and
wherein the control section further performs a control so that templates corresponding to the number of the selected frame images and the selected theme among a plurality of templates are displayed on the display section as candidate templates, according to the second instruction.

6. The image processing device according to claim 3,
wherein the input section receives a second instruction for selecting one or more frame images from among the frame images of the selected theme displayed on the display section as selected frame images, input from the user, and
wherein the control section further performs a control so that templates corresponding to the number of the selected frame images and the selected theme among a plurality of templates are displayed on the display section as candidate templates, according to the second instruction.

7. The image processing device according to claim 4,
wherein the input section further receives a third instruction for selecting one template from among the candidate templates of the selected theme displayed on the display section as a selection template, input from the user, and
wherein the image processing device further comprises:
a composite image generation section that generates a composite image using the selected frame image and the selection template according to the third instruction.

8. The image processing device according to claim 5,
wherein the input section further receives a third instruction for selecting one template from among the candidate templates of the selected theme displayed on the display section as a selection template, input from the user, and
wherein the image processing device further comprises:
a composite image generation section that generates a composite image using the selected frame image and the selection template according to the third instruction.

9. The image processing device according to claim 6,
wherein the input section further receives a third instruction for selecting one template from among the candidate templates of the selected theme displayed on the display section as a selection template, input from the user, and
wherein the image processing device further comprises:
a composite image generation section that generates a composite image using the selected frame image and the selection template according to the third instruction.

10. The image processing device according to claim 1,
wherein the control section performs a control so that the frame images of the selected theme are displayed on the display section by being arranged in the descending order of the scores of the frame images.

11. The image processing device according to claim 2,
wherein the control section performs a control so that the frame images of the selected theme are displayed on the display section by being arranged in the descending order of the scores of the frame images.

12. The image processing device according to claim 3,
wherein the control section performs a control so that the frame images of the selected theme are displayed on the display section by being arranged in the descending order of the scores of the frame images.

13. The image processing device according to claim 1,
wherein the control section performs a control so that the frame images of the selected theme are displayed on the display section by being arranged in a capturing order of the frame images.

14. The image processing device according to claim 1,
wherein the control section performs a control so that the candidate themes are displayed on the display section by being arranged in the descending order of the scores of the themes.

15. The image processing device according to claim 1,
wherein the control section performs a control so that the frame images of each candidate theme are displayed on the display section by being arranged in the descending order of the scores of the frame images, for each candidate theme.

16. An image processing method using the image processing device according to claim 1, comprising:
a step of extracting, for each theme, a plurality of frame images from a moving image based on a different extraction reference for each theme, by a frame image extraction section;
a step of, for each theme, assigning a score to each frame image by evaluating the frame image based on a different evaluation reference for each theme, assigning a score to each theme by adding up the scores of the frame images, and selecting a predetermined number of themes in a descending order of the scores of the themes as candidate themes, by a frame image evaluation section;
a step of correcting, for each candidate theme, a predetermined number of frame images in a descending order of the scores of the frame images based on a different correction reference for each theme, by a frame image correction section;
a step of performing a control so that a name of each candidate theme and the predetermined number of frame images in the descending order of the scores of the frame images, corrected by the frame image correction section, are displayed on the display section as candidate frame images, for each candidate theme, by a control section;
a step of receiving a first instruction for selecting one candidate theme from among the candidate themes displayed on the display section as a selected theme, input from a user, by an input section; and
a step of performing a control so that a name of the selected theme and the candidate frame images of the selected theme corrected by the frame image correction section are displayed on the display section, according to the first instruction, by the control section.

17. The image processing method according to claim 16, further comprising:
a step of further sequentially correcting, after the name of the selected theme and the candidate frame images of the selected theme are displayed on the display section, the remaining frame images of the selected theme other than the candidate frame images of the selected theme based on a correction reference of the selected theme, by the frame image correction section; and
a step of further performing a control, after the name of the selected theme and the candidate frame images of the selected theme are displayed on the display section, so that the remaining frame images of the selected theme sequentially corrected by the frame image correction section are sequentially displayed on the display section, by the control section.

18. The image processing method according to claim 16, further comprising:
a step of receiving a second instruction for selecting one or more frame images from among the frame images of the selected theme displayed on the display section as selected frame images, input from the user, by the input section; and
a step of performing a control so that templates corresponding to the number of the selected frame images and the selected theme among a plurality of templates are displayed on the display section as candidate templates, according to the second instruction, by the control section.

19. The image processing method according to claim 12, further comprising:
a step of further receiving a third instruction for selecting one template from among the candidate templates of the selected theme displayed on the display section as a selection template, input from the user, by the input section; and
a step of generating a composite image using the selected frame image and the selection template according to the third instruction, by a composite image generation section.

20. A computer-readable recording medium that stores a program that causes a computer to execute the steps of the image processing method according to claim 10.
